(19) United States
(12) Patent Application Publication
(10) Pub. No.: US 2025/0055054 A1
(43) Pub. Date: Feb. 13, 2025

(54) BATTERY COOLING DEVICE FOR AN ELECTRICAL BATTERY MODULE OF AN ELECTRIC DRIVE

(71) Applicant: Muhr und Bender KG, Attendorn (DE)

(72) Inventors: Thomas Muhr, Attendorn (DE); Lutz-Eike Elend, Friedland (DE); Björn Scholemann, Drolshagen (DE); Bünyamin Özcan, Attendorn (DE); Christian Begemann, Attendorn (DE); Fabian De Luca, Lüdenscheid (DE); Elisabeth Danger, Paderborn (DE)

(21) Appl. No.: 18/688,375

(22) PCT Filed: Sep. 2, 2022
(86) PCT No.: PCT/EP2022/074461

§ 371 Date: Mar. 1, 2024

(30) Foreign Application Priority Data
Sep. 3, 2021 (DE) 10 2021 122 913.8

(51) Int. Cl. H01M 10/613; H01M 10/625; H01M 10/6556

(52) U.S. Cl. CPC H01M 10/613; H01M 10/625; H01M 10/6556; H01M 2220/20

(57) ABSTRACT

A battery cooling device for an electric battery module of an electric drive on an electric vehicle forms a substantially closed flow chamber for circulating a temperature control fluid. A plurality of flow elements are arranged in the flow chamber, which influence a flow of the temperature control fluid through the flow chamber.

### CROSS-REFERENCE TO RELATED APPLICATIONS

This application is a national stage of, and claims priority to, Patent Cooperation Treaty Application No. PCT/EP2022/074461, filed on Sep. 2, 2022, which application claims priority to German Application No. DE 10 2021 122 913.8, filed on Sep. 3, 2021, which applications are hereby incorporated herein by reference in their entireties.

### BACKGROUND

An electric vehicle comprises, among other things, an electric machine as the drive source, which is electrically connected to electric battery modules as storage means. In drive mode, the electric machine converts electrical energy into mechanical energy to drive the electric vehicle. The electric battery modules, also known simply as batteries or accumulators, are usually cooled with a battery cooling device.

A battery housing for a vehicle driven by an electric motor is known from the publication DE 10 2016 120 826 A1. The battery housing comprises a tray part with a base and side walls molded onto it and a frame structure surrounding the tray part on the outside, which forms a hollow chamber.

A housing arrangement for accommodating electrical storage means for an electrically powered motor vehicle is known from the publication DE 10 2018 106 399 A1. The housing arrangement comprises a tray arrangement and a lid arrangement. The tray arrangement and/or lid arrangement has a first molded part and a second molded part, which are made of flexibly rolled metallic material and joined together so that they have a variable sheet thickness in the longitudinal direction of the respective molded part.

A battery holder for a motor vehicle is known from the publication DE 10 2016 108 849 B3, which has a base plate, a frame running around the side and a cover. The floor panel and the frame are manufactured in one piece and in the shape of a tray from a three-layer laminated composite steel as a formed sheet metal component. An inner layer is made of an acid-resistant steel alloy and an outer layer is made of a stainless steel alloy.

A battery box with lateral reinforcement is known from publication DE 10 2016 115 037 A1. The battery box comprises a side wall construction with a connection profile for connecting the battery box to the vehicle.

A battery box for a traction battery of an electrically powered vehicle is known from the publication DE 10 2014 226 566 B3. The battery box comprises side walls that are designed of a strut construction.

The publication CN 109361037 A discloses a battery pack for electric vehicles with a liquid-cooled plate that is expansion-molded.

A battery cooling arrangement for a motor vehicle is known from the publication EP 3 026 753 A1. The battery cooling arrangement comprises a first and second metal plate, which are connected to each other by means of roll bonding. The two metal sheets are joined together in some areas and spaced apart in other areas, forming cavities to create cooling channels.

The publication DE 10 2016 205 237 A1 discloses a temperature control device for a battery module that has an essentially closed flow chamber with a large number of spacer elements. The spacer elements are arranged within the flow chamber. Furthermore, the temperature control device has a flow deflection unit arranged within the flow chamber. The flow deflection unit has a first end and a second end, with the flow deflection unit having a longitudinal direction running along the flow deflection unit from the first end to the second end.

WO 2021/009256 A1 discloses a housing arrangement with a frame, a base and a cover, which form a housing for electrical storage means. The frame comprises several frame elements made of a metallic material with a variable sheet thickness over the length. The floor is connected to the frame in such a way that a sealed tray is formed. The base can have an integrated cooling structure through which a coolant can flow. The cooling structure can have parallel connecting areas with linear channels in between or the connecting areas are formed by points, resulting in a grid-like cooling structure.

### SUMMARY

The present disclosure relates to a battery cooling device with improved cooling performance for an electric battery module of an electric drive on an electric vehicle.

The battery cooling device according to the disclosure is used for temperature control of an electric battery module for an electric drive of an electric vehicle, wherein the battery cooling device forms an outwardly closed flow chamber for circulating a temperature control fluid and wherein a plurality of flow elements are arranged in the flow chamber, which influence a flow of the temperature control fluid through the flow chamber. At least a share of the flow elements are elongated webs with at least one head portion, with flow taking place around all sides of the elongated webs, wherein a length of the web in the longitudinal direction is greater than its width transverse to the longitudinal direction and wherein the head portion has an increased width transverse to the longitudinal direction which is greater than the smallest width of the web.

An advantage is that the width of the web can be reduced to a minimum in areas with high temperature control requirements in order to increase the surface area covered by the temperature control fluid in the flow chamber. A minimum web width of 1 mm can be achieved with aluminum sheet, for example. The increased width of the head portion prevents excessive thinning in this area, which occurs over the service life due to stress caused by operating loads, such as cyclical loading. Despite the advantageous minimization of the web width, the required service life can thus be achieved. The increased width can be greater than the smallest width of the web by a factor of at least 1.05. The webs can advantageously be shaped both for flow guidance and for targeted structural-mechanical stiffening, whereby the increased width can be greater by a factor of up to 5 than the smallest width of the web. The web can advantageously have a head portion at each end in the longitudinal direction, whereby the head portions of a web can differ in shape and dimensions. The flow chamber that is closed to the outside is to be understood as a fluid-tight enclosed space that can have one or more access points to the outside to allow the temperature control fluid to flow in or out.

The flow chamber is formed between two plates connected to one another in regions by roll bonding, wherein the plates are connected in bonded regions and are inflated in unconnected hollow regions, wherein the flow elements are formed by the bonded regions. Roll bonding can also be referred to as roll cladding. The material bonding is inhibited in the hollow regions by applying a coating before roll bonding. Due to the increased width of the head portion, thinning in this area is advantageously avoided when the hollow regions of the flow chamber between the plates are inflated, for example by introducing compressed air into the regions between the plates that are not bonded. The hollow regions can be inflated on one side in one of the plates or on both sides in both plates. In both cases, the battery cooling device can have a flat contact surface for the battery cells.

The head portion can have a T-shape, Y-shape, cloverleaf shape, heart shape or round shape, whereby the designations are merely intended to illustrate the possible shapes schematically. For example, the head portion has one or more curves, with a minimum radius of the curves being greater by a factor of at least 1.3 than a maximum distance between the plates in a hollow region surrounding the head portion. The distance is to be understood as the distance of the plates in the normal direction to a main extension plane of the plates. The curves of the shape of the head portion, together with the web, can be described as a kind of bone shape.

According to an embodiment, a share of the flow elements can be separating webs around which flow takes place on three sides, wherein the flow chamber has at least two compartments separated from each other by one of the separating webs, which compartments form, for example, a supply and a return for the temperature control fluid. The supply and the return provide for a flow through the entire flow chamber. The separating web can have apertures connecting the compartments, whereby the apertures along the wall have a total length of less than five percent of the total length of the wall. The apertures allow a certain amount of exchange between supply and return, which has the advantage of enabling a more homogeneous temperature control performance.

According to a further embodiment, a share of the flow elements can be fastening regions for connecting the battery cooling device to a battery housing or to the vehicle, around which fastening regions flow takes place on all sides. The fastening region can also be made to influence the flow, for example if the fastening region has a greater extension in a rolling direction used during roll bonding than transverse to the rolling direction. The fastening region has radii of over 5 mm.

According to a further embodiment, the flow chamber can be formed by inflated hollow regions in only a first plate of the two plates, wherein a second plate of the two plates has at least one contact surface for battery modules. In particular, the contact surface can have a flatness of less than 1 mm in order to favorably promote heat transfer between the battery module and the battery cooling device. The second plate can have inflated hollow regions outside the contact surface, for example to influence the flow of the temperature control fluid.

According to a further embodiment, the battery cooling device may have a tray shape, wherein the flow chamber extends over a bottom portion and at least one wall portion connected to the bottom portion of the tray shape. Additionally or alternatively, channels connected to the flow chamber can extend in the wall portion of the tub shape. The hollow regions are inflated after forming into the tray shape. The tray-shaped battery cooling device can be made as part of a battery housing, for example as a receiving base tray or as a cover.

The battery cooling device can have at least one embossing, whereby the embossing is made before or after the plates are expanded. The embossing can be used to accommodate reinforcing elements. By accommodating the reinforcing element in the embossing, for example, a flat surface can be advantageously provided as a contact surface for the battery cells. The embossing in the area of the flow chamber is introduced in particular before the plates are inflated. The embossing can be used to form sealing beads outside the flow chamber. The embossing outside the flow chamber can be introduced after inflation.

The flow chamber may have at least one channel in which the hollow region extends to an edge of the battery cooling device, so that the flow chamber is open to the outside. A fluid connection aligned in the longitudinal direction of the channel can be advantageously connected to the channel in order to feed cooling fluid in or out. The fluid flow through the fluid connection aligned in the longitudinal direction of the channel and the channel itself flows advantageously without deflection approximately parallel to the plane defined by the main directions of extension of the plates into the flow chamber or out of it. One of the plates may alternatively or additionally have at least one opening, wherein a vertical fluid connection is connected to the flow chamber via the opening. A perpendicular fluid connection is a connection through which the fluid flows transversely to the plane defined by the main directions of extension of the plates, however, not necessarily perpendicular to the plane, for example. The opening is arranged, for example, in the first plate, whereby the second plate can have a spherical hollow region opposite the opening in order to improve the flow from the vertical fluid connection into the flow chamber.

Outside the flow chamber, one of the plates can overhang the other plate to save weight. The battery cooling device can be made of corrosion-resistant, high-strength aluminum and thus take on advantageous structural-mechanical tasks. The battery cooling device can have reinforcing hollow profiles introduced during the roll bonding process.

Another aspect of the disclosure, which solves the task formulated above, consists in a battery cooling device for an electric battery module of an electric drive on an electric vehicle according to claim 15. The battery cooling device has an outwardly closed fluid channel for circulating a temperature control fluid, the fluid channel being formed between two plates connected in regions by roll bonding, the plates being connected in bonded regions in a material-locking manner and are inflated in unconnected hollow regions to form the fluid channel. The battery cooling device is tray-shaped with a substantially flat bottom portion and wall portions, and the cooling channel extends from the bottom portion into at least one of the wall portions. The cooling channel can run from the bottom portion via the wall portion to a flange region.

A further aspect of the disclosure relates to a method of manufacturing a battery cooling device, wherein firstly two plates are joined in bonded regions by roll bonding, wherein the plates joined in the bonded regions are formed in a subsequent step, wherein the battery cooling device is formed in such away that it is tray-shaped with a substantially flat bottom portion and wall portions and/or is formed in such a way that the battery cooling device has at least one embossing, and wherein, after forming, unconnected hollow regions between the plates are inflated to form a flow chamber and/or a fluid channel. Roll bonding can take place, for example, before the plates are separated from a strip material, with forming and inflating taking place after separation.

Roll bonding or roll cladding as a manufacturing process for producing the battery cooling device offers various advantages. Depending on the application, for example, various aluminum alloys from soft to high-strength can be used. Higher grades result in a strength advantage, which has a positive effect on crash behavior. Depending on the material, thickness variation and geometry, roll bonding enables very high burst pressures of over 10 bar and/or up to 20 bar. Another advantage is that the strength of the battery cooling device is independent of the temperature. In addition, there is a high degree of flexibility in the design of the battery cooling device, which can be made in one piece with only one upper and lower plate, or in several pieces with a group of upper and lower plates. The flow chamber can be introduced on one side or on both sides. A mixed steel composite is also applicable for the connection technology, for example by using friction welding elements and/or adhesives. The flow chamber created by inflating has a clean inner surface, which has a favorable effect on service life. Improved temperature control is achieved by including the wall portions in the tray-shaped battery cooling device.

### BRIEF SUMMARY OF THE DRAWINGS

Embodiments of the battery cooling device are illustrated below with reference to the attached drawings. Herein

FIG. 1 shows an embodiment of the battery cooling device;

FIG. 2 shows a detail of the embodiment of FIG. 1;

FIG. 3 shows a further embodiment of the battery cooling device;

FIG. 4 shows a detail of the embodiment of FIG. 3;

FIG. 5 shows a perspective view of the embodiment shown in FIG. 3;

FIG. 6 shows a schematic partial sectional view of the embodiment shown in FIG. 5;

FIG. 7 shows a detailed illustration of another embodiment of the battery cooling device;

FIG. 8 shows a further view of the embodiment shown in FIG. 7;

FIG. 9 shows a sectional view of the embodiment shown in FIG. 8;

FIG. 10 shows a detailed illustration of another embodiment of the battery cooling device;

FIG. 11 shows a further illustration of the embodiment shown in FIG. 10;

FIG. 12 shows a sectional view of the embodiment shown in FIG. 12;

FIG. 13 shows a detail of a further embodiment of the battery cooling device in a schematic sectional view;

FIG. 14 shows a further embodiment of the battery cooling device;

FIG. 15 shows an embodiment of a battery cooling device; and

FIG. 16 shows a partial sectional view of the battery cooling device shown in FIG. 15.

### DESCRIPTION

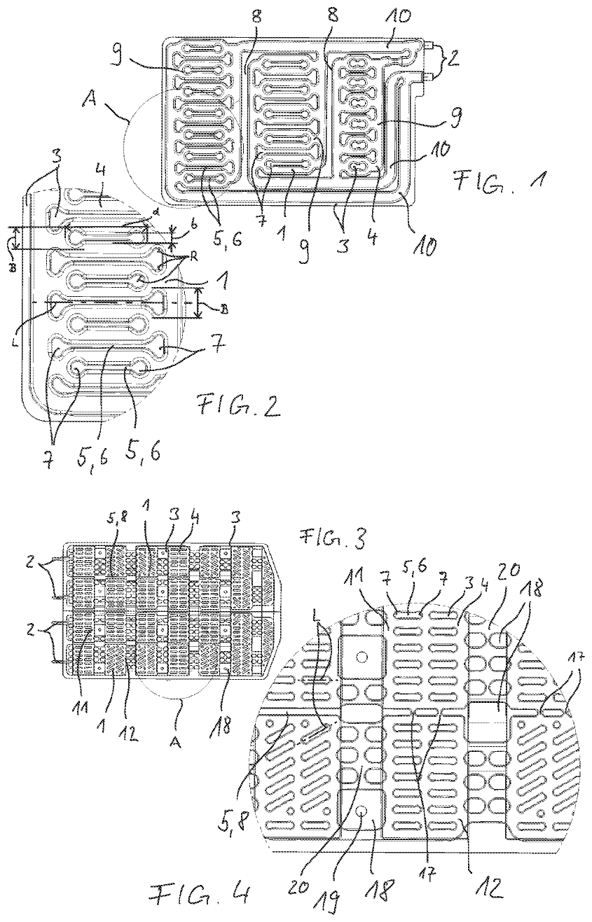

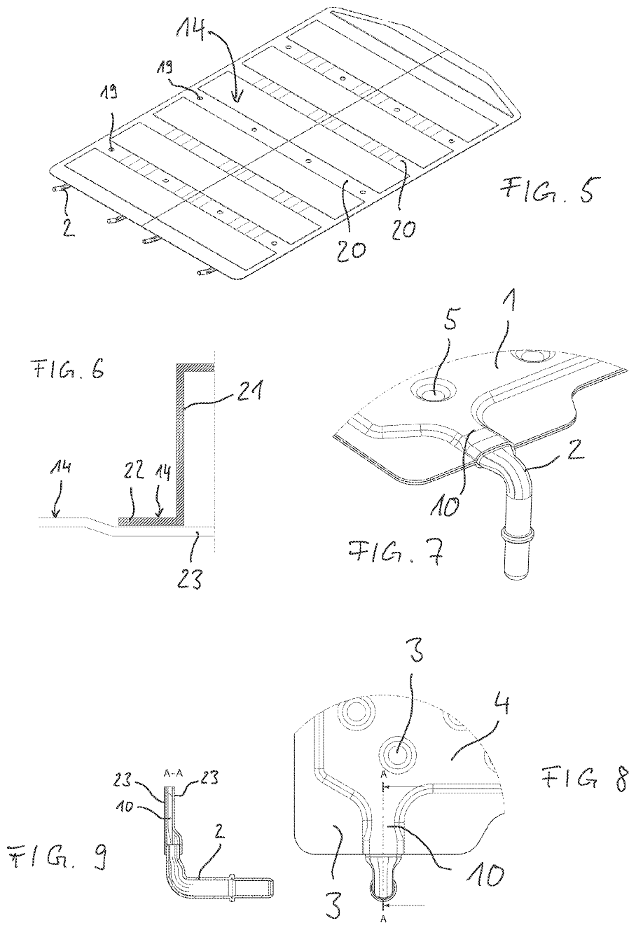

FIG. 1 shows a top view of an embodiment of the battery cooling device. In FIG. 2, detail A from FIG. 1 is shown enlarged. FIGS. 1 and 2 are described together below. The battery cooling device for accommodating an electric battery module (not shown) for an electric drive of an electric vehicle has a substantially closed flow chamber 1 for circulating a temperature control fluid (not shown). Essentially closed means that the flow chamber 1 has outwardly routed connections 2, which serve with a supply and as a return for the temperature control fluid. Apart from that, the flow chamber is closed gas-tight. The flow chamber 1 is formed between two plates connected in regions by roll bonding, wherein the plates are connected to each other in bonded regions 3 and inflated in unconnected hollow regions 4. In roll bonding, also known as roll cladding, the future hollow regions 4 are coated before the plates are rolled, so that only the uncoated regions are bonded to the bonded regions by the rolling process. The unconnected hollow regions 4 are inflated, for example, by introducing compressed air. Only one of the plates can be inflated or both plates.

A plurality of flow elements 5 are arranged in the flow chamber 1, which influence the flow of the temperature control fluid through the flow chamber 1. The flow elements 5 are formed by the bonded regions 3. At least part of the flow elements 5 is s an elongated web 6 and at least one head portion 7, with flow taking place around all sides of the elongated webs. In the case of the elongated web, its length d in a longitudinal direction L of the web is greater than its width b transverse to the longitudinal direction L. The elongated webs 6 with flow around them on all sides are particularly suitable for guiding or redirecting the flow of the temperature control fluid in a suitable or desired manner. In contrast to flow channels, which only allow an essentially one-dimensional flow, the flow chamber 1 offers the possibility of mixing the temperature control fluid in a two-dimensional flow field. This provides a more homogeneous temperature distribution in the fluid and increases the temperature control performance. In addition, the inner surface of the flow chamber 1 that is covered with temperature control fluid is larger than in meandering channels, for example.

The head portion 7 of the web 6 is basically characterized by its increased width B transverse to the longitudinal direction L, which is greater than the smallest width b of the web 6. In the present exemplary embodiment, the width b of the web 6 is approximately constant and thus also corresponds to the smallest width. The increased width B of the head portion 7 prevents excessive thinning of the plates in the transition area between the head portion 7 belonging to the bonded regions 3 and the adjacent hollow region 4 during operation of the motor vehicle. Thinning of the plates can occur over the course of the vehicle's service life due to cyclical loads during operation. Already when inflating the hollow regions 4, the plates thin out in the transition area to the bonded regions 3. A ratio between a radius R at the head portion 7 and a maximum achievable height of the hollow region 4 is at least 1.3. The head portion with increased width B thus enables the shaping of webs 6 with minimized width b without reducing the service life of the battery cooling device. The web 6 with minimized width b increases the inner surface area of the hollow region 4 covered by the temperature control fluid, thereby increasing the temperature control performance.

In the exemplary embodiment shown, webs 6 of different lengths d and different shapes of head portions 7 are arranged in three compartments 9 separated from each other by separating webs 8. The temperature control fluid flows to the compartments 9 and back to the return via a respective channel 10, wherein the channel 10 can supply several compartments 9 as a supply or as a return. In the exemplary embodiment shown, all webs 6 have two head portions 7. In each compartment 9, the shorter webs 6 are provided with head portions 7, which have a constant radius R. This head shape could therefore be described as a round shape. The longer webs 6 of each compartment 9, on the other hand, have two curves with two radii R at each head portion 7. These could be described as T-shaped or Y-shaped. The webs 6 have a characteristic shape, which can also be described as a bone shape.

The three compartments 9 can, for example, each form a contact surface for the battery modules. To ensure good heat transfer, the contact surface should be as flat as possible, for example with a flatness of less than 1 mm.

FIG. 3 shows a top view of another embodiment of the battery cooling device. FIG. 4 shows an enlarged view of detail A from FIG. 3. FIG. 5 shows a perspective view of the embodiment shown in FIG. 3. FIG. 6 shows a schematic partial section of a carrier for holding the battery cooling device according to FIG. 3. FIGS. 3 to 6 are described together below. The perspective view in FIG. 5 shows the flat contact surfaces 14, which can be used to set up the battery modules (not shown). The flat contact surfaces 14 form an inside or are an interior of a battery housing. The bonded regions 3 and hollow regions 4 formed by roll bonding and inflating can be seen on the outside of the battery cooling device opposite the contact surfaces 14, which is shown in FIGS. 3 and 4. The illustrated embodiment of the battery cooling device shows two essentially closed flow chambers 1, each of which has a pair of outwardly directed connections 2, each of which is connected to a supply 11 and a return 12 for each flow chamber 1. The flow chambers 1 of the exemplary embodiment shown are identical or mirror-symmetrical to a center line. A large number of different flow elements 5, which are described below, can be seen, particularly in the enlarged view.

In this embodiment, part of the flow elements 5 is also an elongated web 6 and at least one head portion 7 with flow around all sides. The enlarged view shows that the head portion 7 has an increased width B transverse to the longitudinal direction L, which is greater than the smallest width b of the web 6. For example, the increased width B is greater than the smallest width b of the web 6 by a factor of at least 1.05. In the exemplary embodiment shown, the two head portions 7 of each web 6 have a round shape with a radius R. The minimum radius R is greater by a factor of at least 1.3 than the maximum distance between the plates in the hollow region 4. The webs 6 are arranged in groups parallel to each other, whereby the longitudinal directions L of the webs 6 of different groups can include different angles with each other. This specifically influences the flow in the flow chamber 1 in order to favorably influence the temperature control performance.

A further part of the flow elements 5 is a separating web 8 with flow around three sides, wherein in the present exemplary embodiment each of the flow chambers 1 is divided into two compartments 9 separated from each other by the respective separating web 8. Each of the two compartments 9 is connected to a connection 2 and the compartments 9 are connected to each other on the side of the flow chamber 1 opposite the connections 2. The separating web 8 is connected at its first end 15 to the bonded regions 3 delimiting the flow chamber 1, while flow takes place around its second end 16 in the flow chamber 1. The two compartments 9 thus advantageously form the supply 11 and the return 12 for the temperature control fluid. The separating web 8 may have apertures 17 connecting the compartments 9, the apertures 17 along the separating web 8 having a total length of less than 5% of the total length of the separating web 8. The apertures 17 allow a locally limited mixing of the temperature control fluid from the supply 11 and the return 12 in order to specifically influence the temperature control performance.

Another share (i.e., some) of the flow elements 5 is a fastening region 18 with flow around all sides, the fastening region 18 being made to connect the battery cooling device to a supporting structure, for example a battery housing or a component of the vehicle (not shown). The fastening region 18 may have a greater extent in a rolling direction applied during roll bonding than transversely to the rolling direction, whereby the fastening region 18 can contribute to influencing the flow of the tempering fluid. Holes 19, for example, can be provided in the fastening region 18 as connecting elements. In the exemplary embodiment shown, fastening regions 18 of different sizes are arranged in six groups, with the groups extending as parallel strips transverse to the main flow direction of the supply 11 and the return 12 over the entire battery cooling device. In the perspective view of FIG. 5 of the contact surface 14 for the battery modules, the groups of fastening regions 18 arranged in strips are also recognizable, with the holes 19 being provided in only a part of these strips and only in certain fastening regions 18. On the side of the contact surface 14, the battery cooling device has embossings 20 along the strips with the fastening regions 18 for receiving reinforcing elements 21. The embossing 20 can be made into the battery cooling device or the flow chamber 1 before or after roll bonding and inflating. FIG. 6 schematically shows a half-section of the plate 23 forming the contact surface 14 in the area of the embossing 20 with the reinforcing element 21, which is used, for example, for transverse stiffening of the battery cooling device. The depth of the embossing 20 corresponds to the thickness of a flange portion 22 of the reinforcing element 21. As a result, the contact surface 14 for the battery modules in the area of the embossing 20 is formed by the flange section 22. This provides optimum utilization of the available installation space with good heat transfer.

In addition to the flow elements 5 described, further circular or elongated bonded regions 3, around which the flow passes on all sides or partly, can be provided in the flow chamber 1, which contribute to influencing the flow and/or provide the strength of the battery cooling device. All radii of the curves of the flow elements 5 or bonded regions 3 adjacent to the hollow regions 4 are larger by a factor of at least 1.3 than a maximum distance between the plates in the hollow region 4. For example, these curves can have radii of at least 5 mm.

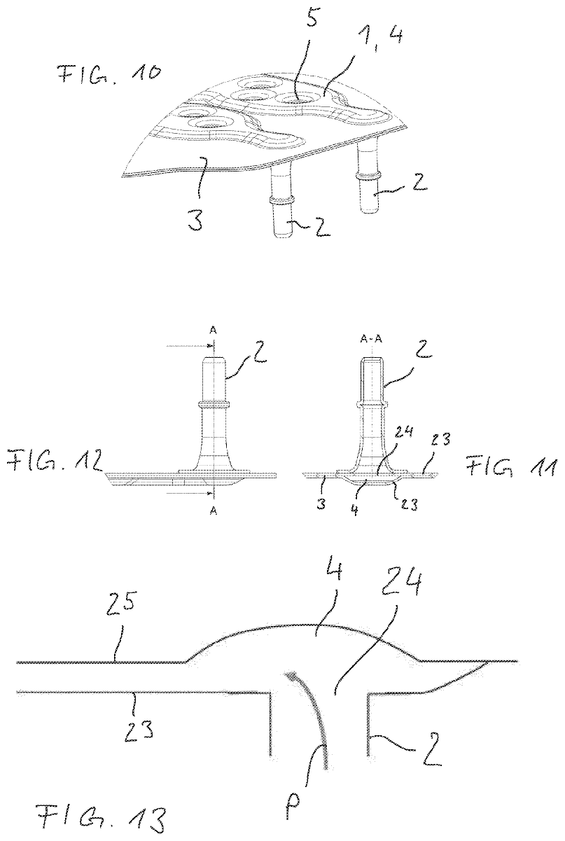

FIG. 7 shows a detailed perspective view of a further embodiment of the battery cooling device, with only a part of the battery cooling device being visible. The embodiment shown can be combined with the embodiments described above. FIG. 8 shows a top view of the embodiment. FIG. 9 shows a partial section along line A-A in FIG. 8. FIGS. 7 to 9 are described together below. The flow chamber 1 has a channel 10 which extends to the edge of the battery cooling device, so that the hollow region 4 formed between the plates 23 has an opening to the outside. A connection 2 for introducing or discharging the temperature control fluid is connected to the channel 10 in a gas-tight manner. The fluid connection 2 aligned in the longitudinal direction of the channel 10 advantageously guides the fluid flow into or out of the flow chamber 1 without deflection approximately parallel to the plane defined by the main directions of extension of the plates 23, 25. As shown in the illustration, the parallel fluid connection 2 can be angled.

FIG. 10 shows a detailed perspective view of a further embodiment of the battery cooling device, with only a part of the battery cooling device being visible. The embodiment shown can be combined with the embodiments described above. FIG. 11 shows a top view of the embodiment. FIG. 12 shows a partial section along line A-A in FIG. 11. FIGS. 10 to 12 are described together below. One of the plates 23 has two openings 24, which open the flow chamber 1 to the outside. At each opening 24, a connection 2 is connected to the surface of the plate 23 in a gas-tight manner in order to feed temperature control fluid into the flow chamber 1 or to discharge it from it. The fluid flow is transverse to the plane defined by the main directions of extension of the plates 23, 25. The opening is arranged, for example, in the first plate, whereby the second plate can have a spherical hollow region opposite the opening in order to improve the flow from the vertical fluid connection into the flow chamber.

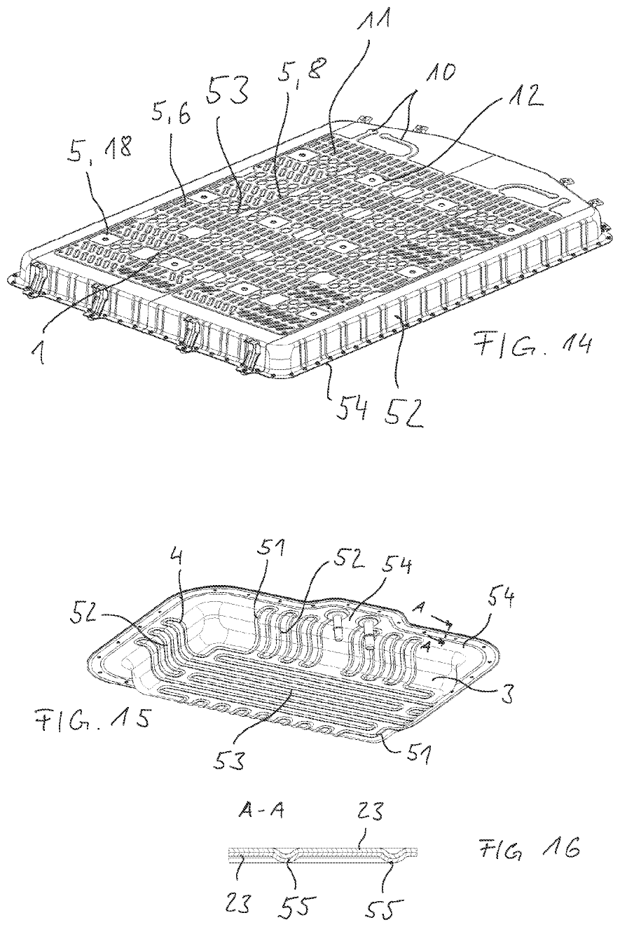

FIG. 13 shows a schematic representation of a partial section of a further embodiment of the battery cooling device. The partial section shows an alternative version of the vertical fluid connection 2. At each opening 24, the vertical fluid connection 2 is connected gas-tight to the surface of the first plate 23 in order to feed temperature control fluid into or discharge it from the flow chamber 1. The fluid flow is transverse to the plane defined by the main directions of extension of the plates 23, 25. The second plate 25 has a spherical hollow region 4 opposite the opening 24 in order to enhance the flow (arrow P) from the vertical fluid connection 2 into the flow chamber 1. The spherical hollow region 4 is made by a corresponding forming tool during inflating. The flow chamber 1 can be formed with inflated hollow regions 4 in only the first plate 23, so that the second plate 25 can form the contact surface 14 for the battery module in order to advantageously enhance the heat transfer between the battery module and the battery cooling device. The second plate 25 can nevertheless have the spherical hollow region 4 shown here, for example, outside the contact surface in order to influence the flow of the temperature control fluid locally.

FIG. 14 shows a perspective view of a further embodiment of the battery cooling device. The battery cooling device is characterized by a tray-shaped form, with the flow chamber 1 extending at least over a bottom portion 53 of the tray-shaped form. The flow chamber 1 can also extend from the bottom portion 53 into at least one wall portion 52 connected to the bottom portion 53 of the tray-shaped device. In addition, at least one fluid channel may be connected to the flow chamber 1 and extend into the wall portion 52. The flow chamber 1 of the tray-shaped battery cooling device can be made in a similar way to the exemplary embodiment shown in FIG. 3. The flow chamber 1 has, for example, the following flow elements 5: elongated webs 6 with head portions 7 with flow around all sides, separating webs 8 with flow around three sides and fastening regions 18. The channels 10 are connected to the supply 11 and the return 12. In the supply 11, the webs 6 are recognizably aligned from the edge of the battery cooling device towards the separating web 8 or aligned in such a way that the fluid flow is directed from the edge towards the separating web 8, as a lower temperature control capacity is required in the edge area than in the central area of the flow chamber 1. At the end of the flow chamber 1 opposite the channels 10, the fluid flow is diverted from the supply 11 to the return 12. This redirection is further promoted by a corresponding alignment of the webs 6. The fastening regions are arranged in strips transverse to the flow directions in the supply 11 and in the return 12.

FIG. 15 shows another aspect in a perspective view. The battery cooling device for an electric battery module of an electric drive on an electric vehicle has a substantially closed fluid channel 51 for circulating the temperature control fluid. The fluid channel 51 is formed between two plates connected in certain regions by roll bonding, the plates being bonded in bonded regions 3 and inflated in unconnected hollow regions 4 to form the fluid channel 51. The battery cooling device has a tray-shaped form and the cooling channel 51, which is formed after the roll bonding, extends from a bottom portion 53 of the tray into wall portions 52 of the tray and back again. The fluid channel 51 can also extend into a flange area 54 of the tray-shaped battery cooling device. In the exemplary embodiment shown, the connections 2 in the flange area 54 are connected to the beginning and to the end of the fluid channel 51. FIG. 14 shows a partial section along line A-A from FIG. 13. It illustrates a detail of the embodiment, according to which two circumferential sealing beads 55 are made into both plates 23 by embossing in the flange area 54. The sealing beads 55 can be embossed after the cooling channel 51 has been inflated.

### LIST OF REFERENCE NUMBERS

1 Flow chamber
2 Connection
3 Bonded regions
4 Hollow regions
5 Flow elements
6 Elongated web with flow taking place around all sides
7 Head portion
8 Separating web
9 Compartment
10 Channel
11 Supply
12 Return
14 Contact surface
15 First end
16 Second end
17 Apertures
18 Fastening region
19 Holes
20 Embossing
21 Reinforcing element
22 flange portion
23 First plate
24 Openings
25 Second plate
51 Fluid channel
52 Wall portion
53 Bottom portion
54 Flange area
55 Sealing beads
L Longitudinal direction
d Length
b Smallest width
B Increased width
R Radius
P Arrow

1.-15. (canceled)

16. A battery cooling device for an electric battery module of an electric drive on an electric vehicle, comprising:
an outwardly closed flow chamber for circulating a temperature control fluid,
wherein the flow chamber is formed between two plates connected to one another in regions by roll bonding, wherein the plates are connected in bonded regions and are inflated in unconnected hollow regions to form the flow chamber, wherein the flow elements are formed by the bonded regions,
wherein a plurality of flow elements are arranged in the flow chamber, which influence a flow of the temperature control fluid through the flow chamber,
wherein at least some of the flow elements are elongated webs with at least one head portion, with flow taking place around all sides of the elongated webs,
wherein a length of the web in the longitudinal direction is greater than a width transverse to the longitudinal direction,
wherein the head portion has an increased width transverse to the longitudinal direction which is greater than the smallest width of the web.

17. The battery cooling device of claim 16, wherein the increased width is greater by a factor of at least 1.05 than the smallest width of the web.

18. The battery cooling device of claim 16, wherein the head portion has one or more curves, a minimum radius of the curves being greater by a factor of at least 1.3 than a maximum distance between the plates in the hollow region surrounding the head portion.

19. The battery cooling device of claim 16, wherein a share of the flow elements are separating webs around which flow takes place on three sides, the flow chamber having at least two compartments separated from one another by one of the separating webs.

20. The battery cooling device of claim 19, wherein the two compartments form a supply and a return for the temperature control fluid.

21. The battery cooling device of claim 19, wherein the separating web has apertures connecting the compartments, the apertures along the separating web having a total length of less than five percent of a total length of the separating web.

22. The battery cooling device of claim 16, wherein a share of the flow elements are fastening regions for connecting the battery cooling device to a battery housing or to the vehicle, around which fastening regions flow takes place on all sides.

23. The battery cooling device of claim 16, wherein the battery cooling device has a tray shape, the flow chamber extending over a bottom portion and at least one wall portion connected to the bottom portion of the tray shape.

24. The battery cooling device of claim 16, wherein the flow chamber is formed by inflated hollow regions in a first plate of the two plates, a second plate of the two plates having at least one contact surface for battery modules, the contact surface having a flatness of less than 1 mm.

25. The battery cooling device of claim 24, wherein the second plate has inflated hollow regions outside the contact surface.

26. The battery cooling device of claim 16, wherein the battery cooling device has at least one embossing, the embossing being made before or after the inflation of the flow chamber.

27. The battery cooling device of claim 16, wherein the flow chamber has at least one channel in which the hollow region extends to an edge of the battery cooling device, a parallel fluid connection being connected to the channel.

28. The battery cooling device of claim 16, wherein one of the plates has at least one opening, wherein an angled fluid connection is connected to the flow chamber via the opening.

29. Battery cooling device for an electric battery module of an electric drive on an electric vehicle, comprising:
an outwardly closed fluid channel for circulating a temperature control fluid,
wherein the fluid channel is formed between two plates connected in regions by roll bonding, wherein the plates are connected in bonded regions in a material-locking manner and are inflated in unconnected hollow regions to form the fluid channel,
wherein the battery cooling device is tray-shaped with a substantially flat bottom portion and wall portions and wherein the cooling channel extends from the bottom portion into at least one of the wall portions.

30. Battery cooling device for an electric battery module of an electric drive on an electric vehicle,
wherein the battery cooling device has an outwardly closed flow chamber for circulating a temperature control fluid,
wherein the flow chamber is formed between two plates connected to one another in regions by roll bonding, wherein the plates are connected in bonded regions and are inflated in unconnected hollow regions to form the flow chamber, wherein the flow elements are formed by the bonded regions,
wherein a plurality of flow elements are arranged in the flow chamber, which influence a flow of the temperature control fluid through the flow chamber,
wherein at least a share of the flow elements are elongated webs with at least one head portion, with flow taking place around all sides of the elongated webs,
wherein a length of the web in the longitudinal direction is greater than its width transverse to the longitudinal direction,
wherein the head portion has an increased width transverse to the longitudinal direction which is greater than the smallest width of the web,
wherein the head portion has one or more curves, a minimum radius of the curves being greater by a factor of at least 1.3 than a maximum distance between the plates in the hollow region surrounding the head portion.

31. The battery cooling device of claim 30, wherein the increased width is greater by a factor of at least 1.05 than the smallest width of the web.

32. The battery cooling device of claim 30, wherein the battery cooling device has a tray shape, the flow chamber extending over a bottom portion and at least one wall portion connected to the bottom portion of the tray shape.

33. The battery cooling device of claim 30, wherein the battery cooling device has at least one embossing, the embossing being made before or after the inflation of the flow chamber.

34. The battery cooling device of claim 30, wherein the flow chamber has at least one channel in which the hollow region extends to an edge of the battery cooling device, a parallel fluid connection being connected to the channel.
